(19) United States
(12) Patent Application Publication
(10) Pub. No.: US 2025/0151019 A1
(43) Pub. Date: May 8, 2025

(54) POSITIONING ENHANCEMENT METHODS

(71) Applicant: ZTE Corporation, Shenzhen (CN)

(72) Inventors: Mengzhen LI, Shenzhen (CN); Chuangxin JIANG, Shenzhen (CN); Focai PENG, Shenzhen (CN); Yu PAN, Shenzhen (CN); Qi YANG, Shenzhen (CN); Junpeng LOU, Shenzhen (CN)

(21) Appl. No.: 19/014,792

(22) Filed: Jan. 9, 2025

Related U.S. Application Data
(63) Continuation of application No. PCT/CN2023/072724, filed on Jan. 17, 2023.

(51) Int. Cl. H04W 64/00; H04L 5/00

(52) U.S. Cl. CPC H04W 64/00; H04L 5/0048; H04L 5/0094

(57) ABSTRACT

This patent application discloses methods, apparatus, and systems that positioning enhancement in wireless communication systems. In one example aspect, a method for wireless communication includes receiving, by a wireless device, from a network device, a configuration information of positioning reference signal (PRS) related to a plurality of positioning frequency layers, wherein the plurality of positioning frequency layers are associated; measuring, by the wireless device, the positioning reference signal related to positioning frequency layers based on the configuration information; and reporting, by the wireless device to a network device, the positioning measurements related to positioning frequency layers based on the configuration information

### CROSS REFERENCE TO RELATED APPLICATIONS

This patent document is a continuation of and claims benefit of priority to International Patent Application No. PCT/CN2023/072724, filed on Jan. 17, 2023. The entire content of the before-mentioned patent application is incorporated by reference as part of the disclosure of this application.

### TECHNICAL FIELD

This patent document is related to wireless communication.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This patent document discloses techniques, among other things, related to positioning enhancement methods in a wireless communication network.

In one example aspect, a wireless communication method is disclosed. The method receiving, by a wireless device, from a network device, a configuration information of positioning reference signal (PRS) related to a plurality of positioning frequency layers, wherein the plurality of positioning frequency layers are associated; measuring, by the wireless device, the positioning reference signal related to positioning frequency layers based on the configuration information; and reporting, by the wireless device to a network device, the positioning measurements related to positioning frequency layers based on the configuration information.

In another example aspect, another wireless communication method is disclosed. The method includes receiving, by a network device, a request for a configuration information of positioning reference signal (PRS) sending from a wireless device; and transmitting, by the network device, a positioning reference signal's configuration information related to a plurality of frequency layers to the wireless device.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

### BRIEF DESCRIPTION OF THE DRAWING

FIG. 1 shows an example diagram of carrier aggregation (CA) of two component carriers (CC), in accordance with some embodiments of the present document.

FIG. 2 shows an example diagram indicating a network device transmits downlink positioning reference signal (DL-PRS) to a wireless device and a wireless device measures and processes DL-PRS resources, in accordance with some embodiments of the present document.

FIG. 3 shows an example diagram of a procedure of PRS configuration, in accordance with some embodiments of the present document.

FIG. 4 shows an example of positioning processing window (PPW) configuration in CA scenario, in accordance with some embodiments of the present document.

FIG. 5 shows an example of the PPW Activation/Deactivation Command Medium Access Control element (MAC CE), in accordance with some embodiments of the present document.

FIG. 6 shows an example of PPW configuration in the CA scenario, per some embodiments of the present document.

FIGS. 7A-7C show examples of PPW Activation/Deactivation Command MAC CE, in accordance with some embodiments of the present document.

FIG. 8 shows an example of DL-PRS frequency hopping in accordance with some embodiments of the present document.

FIG. 9 shows another example of PPW Activation/Deactivation Command MAC CE, in accordance with some embodiments of the present document.

FIG. 10 shows an example of multiple activated PPWs not overlapping in time domain in accordance with some embodiments of the present document.

FIG. 11 shows an example of multiple activated PPWs overlapping in time domain in CA scenarios, in accordance with some embodiments of the present document.

FIG. 12 shows another example of a scenario when multiple Bandwidth Part (BWP) each belonging to a CC/carrier/cell are not activated simultaneously, in accordance with some embodiments of the present document.

FIG. 13 shows another example of one scheduling grant schedules SRS resources of multiple CCs, in accordance with some embodiments of the present document.

FIG. 14 shows an example of is a block diagram of an example of a hardware platform that may be a part of a network device or a communication device, in accordance with some embodiments of the present document.

FIG. 15 shows an example of network communication including a network device (BS) and wireless device based on some implementations of the disclosed technology.

FIGS. 16-19 are flowcharts representation of methods for wireless communication in accordance with one or more embodiments of the present technology.

### DETAILED DESCRIPTION

Section headings are used in the present document to facilitate understanding and do not limit the scope of the disclosed technology to particular sections. Furthermore, certain terminology referring to 5G and Third Generation Partnership Project (3GPP) protocols is used as an illustrative example and the disclosed techniques are applicable to other wireless protocols also.

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale. In should be noted, in the disclosure of this patent application, a network node can be at least one of a Location Management Function (LMF), a Base Station (BS) (e.g., gNB, and/or TRP), or a core network.

In a 5G network, a roaming UE in a visited public land mobile network (VPLMN) may need to access an internal application function in a VPLMN or a home public land mobile network (HPLMN).

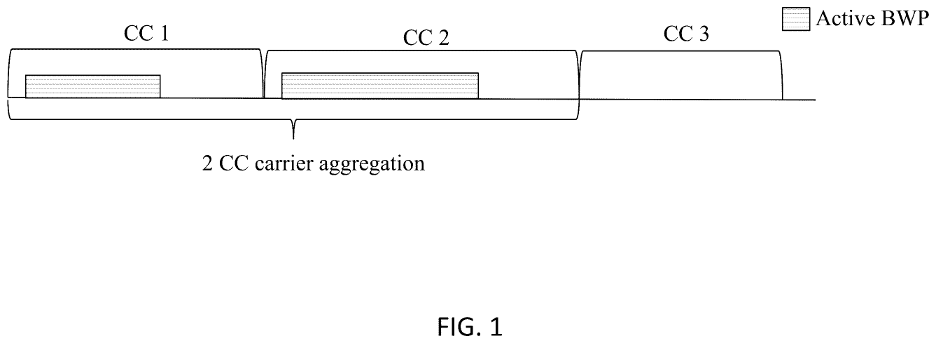

Describe FIG. 1 here . . . . Here, the horizontal axis represents frequency resources. As depicted, three carriers, CC1, CC2 and CC2 may be available, with CC1 and CC2 joined together via CA, and specifically all or some of CC1 and CC2 being configured as bandwidth part BWP) for wireless communication.

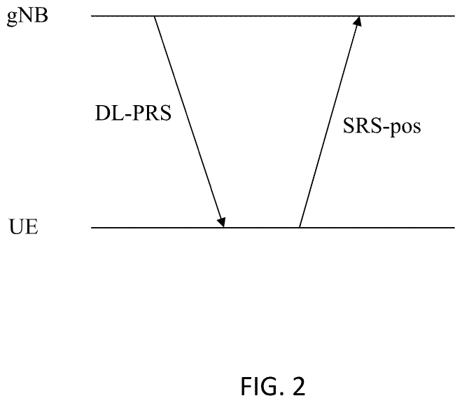

In current technology, as illustrated in FIG. 2, UE can perform positioning with a network via an interface by sending a Sounding reference signal (SRS) signal and/or receiving a Positioning reference signal (PRS) signal. Large bandwidth is required for high-accuracy positioning especially when timing-based positioning methods (e.g. TDOA, RTT) are used, the larger the bandwidth, the higher the positioning accuracy. In Carrier Aggregation (CA), two or more Component Carriers (CCs) are aggregated. A UE may simultaneously receive or transmit on one or multiple CCs depending on its capabilities. It is possible to achieve higher positioning accuracy by enlarging the positioning reference signal (RS) (e.g., PRS, SRS for positioning purposes) bandwidth through carrier aggregation technology.

However, under the existing standard, there is no method to solve the positioning configuration in the CA scenario. In this patent application, methods, and procedures of signaling transfer are provided to specify positioning in CA scenarios. The proposed methods are beneficial at least for increasing the accuracy and efficiency of positioning procedures in wireless communication networks. To improve or enhance the positioning accuracy (e.g., satisfying or meeting a high-accuracy positioning requirement), the systems and methods discussed herein can include processes, procedures, and/or implementations for signaling.

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present document that various modifications to the disclosed embodiments can be made while remaining within the scope of this disclosure.

### Initial Introduction (Background of Positioning in CA Scenario)

Currently, only the signaling and procedure of positioning in a single carrier (e.g. 100 MHz in FR, 400 MHz in FR2) is specified, but the positioning accuracy is quite limited and hard to meet the requirement.

### Background of Positioning Processing Window (PPW)

In Rel-16 positioning, during a measurement gap (MG), the UE is expected to measure the DL-PRS resource outside the active DL BWP or with a numerology different from the numerology of the active BWP. In order for latency reduction, DL PRS measurement without MG within PPW is supported, wherein the UE is expected to measurement the DL-PRS resource if it is inside the active DL BWP or with the same numerology as the active DL BWP.

TS 38.214
Inside one DL-PPW-PreConfig the UE is only expected to measure a single DL PRS
positioning frequency layer.
TS 38.331
The IE DL-PPW-PreConfig provides configuration for a measurement window where a UE
is expected to measure the DL PRS, if it is inside the active DL BWP and with the same
numerology as the active DL BWP. Based upon the indication received in the
configuration, the UE identifies whether the DL PRS priority is higher than that of the other
DL signals or channels and accordingly determines, for example, the UE is expected to
measure the DL PRS and is not expected to receive other DL signals and channels.
DL-PPW-PreConfig-r17 ::= SEQUENCE {
dl-PPW-ID-r17 DL-PPW-ID-r17,

| | |
|---|---|
| dl-PPW-Periodicity-and-StartSlot-r17 | DL-PPW-Periodicity-and-StartSlot-r17, |
| length-r17 | INTEGER (1..160), |
| type-r17 | ENUMERATED {type1A, type1B, type2} |

OPTIONAL, -- Cond MultiType

| | |
|---|---|
| priority-r17 | ENUMERATED {st1, st2, st3} |

OPTIONAL -- Cond MultiState
}

In the following discussion, Component Carrier (CC) can also be a serving cell or positioning frequency layer to be aggregated for positioning in a CA scenario.

In the following discussion, the term ““bandwidth aggregation””, “carrier aggregation”, and “frequency layer aggregation” are equivalent.

In the following discussion, the network device (e.g. the first network device, the second network device) may be any wireless network, such as a cellular network or a narrowband Internet of things (NB-IoT) network. The network device (e.g. the first network device, the second network device) can be at least one of a Location Management Function (LMF), a Base Station (BS) (e.g., gNB, and/or Transmission-Reception Point (TRP)), or a core network, an evolved node B (eNB), a serving eNB, a target eNB, a femto station, or a pico station.

In some embodiments, the UE may be embodied in various types of user devices such as a mobile phone, a smart phone, a personal digital assistant (PDA), a tablet, a laptop computer, a wearable computing device, etc. As may be discussed herein, the UE can correspond to, be associated with, or be a part of a vehicle (e.g., a vehicle UE), a mobile UE, a road side unit (RSU), a positioning reference unit (PRU), and/or any other types of UEs that supports Uu communication and/or V2X service, sidelink communication.

### Embodiment 1

This section discloses, among other things, PRS configuration under the scenario where two or more positioning frequency layer (PFL)/CC are associated or a wide bandwidth for one PFL.

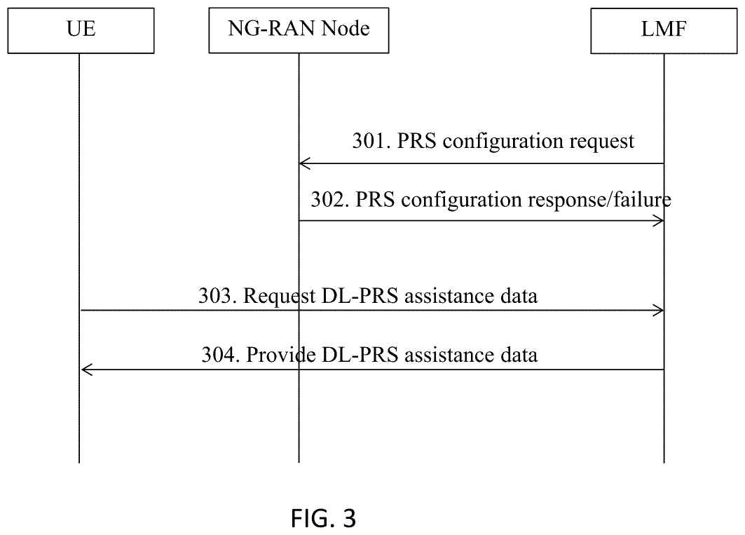

The procedure is shown in FIG. 3. Before the Location Management Function (LMF) provide DL-PRS assistance data to UE, the PRS configuration exchange procedure is required between LMF and NG-RAN node (e.g. gNB), where the LMF will send a PRS configuration request to NG-RAN Node (step 301) and NG-RAN node can provide a list of PRS resource set configurations and PRS resource configurations to LMF (step 302). A UE may send a request of DL-PRS positioning assistance data to LMF (step 303) and LMF can provide DL-PRS assistance data to the UE (step 304). The UE can be configured with one or more DL-PRS positioning frequency layer (PFL) configuration(s) as indicated by LMF via DL-PRS assistance data. A DL PRS PFL is defined by LMF as a collection of DL PRS resource sets which share some common parameters (Subcarrier Spacing (SCS), resource bandwidth, startPRB, point A, comb size and cyclic prefix).

To achieve high-accuracy positioning especially when timing-based positioning methods (e.g., TDOA, RTT) is applied, aggregation of PRS/SRS resources across PFLs/carriers for positioning measurements should be supported. The configuration information of the positioning reference signal (PRS) of the plurality of positioning frequency layers are associated. UE may be configured with one or more PRS frequency layer groups (PFL groups). The term PFL group is used to describe or possibly specify the plurality of associated PFLs. Each PRS PFL group includes two or more PRS PFLs. Multiple PRS PFL configurations belonging to the same PRS PFL group share some common parameters, whereas some of the parameters are unique for each PFL, for example: bandwidth, point A, start PRB and etc.

The common configuration parameters for multiple associated PRS PFLs include at least one of the following parameters:
Common numerology: SCS
A common Transmission-Reception Point (TRP) identity (ID)
A common ARP (antenna reference point)
Same “assistance data reference” TRP and System Frame Number (SFN) 0 offset (the time offset of the SFN #0 slot #0 for the given TRP with respect to SFN #0 slot #0 of the assistance data reference TRP)
DL-PRS resource set ID
DL-PRS resource ID
DL-PRS periodicity
DL-PRS resource set slot offset
DL-PRS resource repetition factor: how many times each DL-PRS Resource is repeated for a single instance of the DL-PRS Resource Set
Time gap: the offset between two repeated instances of a DL-PRS Resource corresponding to the same DL-PRS Resource ID within a single instance of the DL-PRS Resource Set
Muting pattern: DL PRS muting configuration of the TRP
DL-PRS symbol number: the number of symbols per DL-PRS Resource within a slot
DL-PRS resource slot offset
DL-PRS resource symbol offset
DL-PRS comb size and RE offset
DL-PRS sequence ID
Priority of the DL-PRS
DL-PRS Quasi co-location (QCL) info: the QCL indication with other DL reference signals for serving and neighboring cells
Power for DL-PRS transmission
DL-PRS expected Reference Signal Time Difference (RSTD) and expected RSTD uncertainty

By sharing some common configurations among multiple PFL in one PFL group, PRS resources to be aggregated from different PFLs in the same PFL group can transmit simultaneously in the same slot and same symbol.

Alternatively, for multiple associated PFLs, the configuration of a reference PFL can be received by UE from the network device (via RRC signaling, or signaling informed by LMF). UE may be configured with one or more PRS frequency layer group (PFL group). PRS PFL configurations belonging to the same PRS PFL group are associated with the reference PFL configuration. The association relationships and the configuration of reference PFL can be configured/indicated by higher layer signaling, e.g. RRC signaling, or signaling informed by LMF.

The following Table 1 shows one way to provide CA info in PRS assistance data in TS 37.355. NR-DL-PRS-PositioningFrequencyLayer-CA (PFL group) indicate a list of PFLs (NR-DL-PRS-PositioningFrequencyLayer-CC) to be aggregated. The number of PFLs is from 1 to the maximum number of CC/PFL for CA. Multiple PFLs share the same SCS, comb size and cyclic prefix. And each PFL has its own resource bandwidth, start PRB and point A. Moreover, either a bitmap (e.g. dl-PRS-referenceFrequencyLayer, 0 means this PFL is not reference PFL and 1 means this PFL is the reference PFL) configured for each PFL or an ID of the reference frequency layer (dl-PRS-referenceFrequencyLayer-ID) configured in each PFL group configuration can be introduced.

TABLE 1

| (2) | NR-DL-PRS-PositioningFrequencyLayer-CA ::= SEQUENCE { | | |
|---|---|---|---|
| (3) | nr-DL-PRS-PositioningFrequencyLayer-List | SEQUENCE | (SIZE |

(1..nrMaxFreqLayerPerPFLGroup)) OF NR-DL-PRS-PositioningFrequencyLayer-CC,

| (4) | dl-PRS-SubcarrierSpacing-r16 | ENUMERATED {kHz15, kHz30, kHz60, kHz120, ...}, |
|---|---|---|
| (5) | dl-PRS-CombSizeN-r16 | ENUMERATED {n2, n4, n6, n12, ...}, |
| (6) | dl-PRS-CyclicPrefix-r16 | ENUMERATED {normal, extended, ... }, |
| (7) | dl-PRS-referenceFrequencyLayer-ID INTEGER (1,2,3,4) | |
| (8) | ... | |
| (9) | } | |
| (10) | NR-DL-PRS-PositioningFrequencyLayer-CC ::= SEQUENCE { | |
| (11) | dl-PRS-referenceFrequencyLayer BIT STRING (SIZE(2)) | |
| (12) | dl-PRS-ResourceBandwidth-r16 | INTEGER (1..63), |
| (13) | dl-PRS-StartPRB-r16 | INTEGER (0..2176), |
| (14) | dl-PRS-PointA-r16 | ARFCN-ValueNR-r15, |

| | |
|---|---|
| (15) | ...} |

Alternatively, a unique PFL for carrier aggregation with a wider bandwidth can be configured. The straightforward way to extend the frequency range of PRS resources is to enlarge the bandwidth for DL-PRS resources in a PFL (e.g. dl-PRS-ResourceBandwidth). The maximum allocated DL-PRS bandwidth of PFL for carrier aggregation is associated with or related to both the maximum bandwidth configured for one PFL (e.g. 272 PRB) and the maximum number CCs/PFLs to be aggregated.

Only the UE which supports CA-related capability can successfully receive/measure the wide-band PRS resources.

Accordingly, at least one of the following signaling should be included:
1. PRS configuration request from LMF to NG-RAN node: LMF may request the NG-RAN node to configure/update/change PRS CA-related configuration. For example, LMF can use 1 or more bit(s) to indicate whether PRS resources to be aggregated from different PFLs is required, or LMF can use 1 or more bit(s) to indicate the present/absent of the PFL group. Moreover, the request signaling may also include explicit parameters for CA based PRS configuration, or a request to change the PFL group, or a request for the association between PFLs, or a request for the indication of reference PFL.
2. PRS configuration response from NG-RAN node to LMF: NG-RAN node may further response to LMF's request with PRS CA related configuration in 1. For example, NG-RAN node can provide a list of DL-PRS resources for one TRP, where the PRS resources or PRS resource sets from different PFLs can be aggregated. Moreover, NG-RAN node can provide multiple PRS PFL configurations and their association information to LMF. NG-RAN may also mark a certain PFL in PFL group as a reference PFL, for example, all other PFLs in a PFL group may share the same PPW configuration of the reference PFL.
3. Request DL-PRS assistance data from UE to LMF: For UE-initiated on-demand PRS transmission, UE can send the PRS configuration request to LMF, and LMF may further decide and control the PRS transmission (3->1->2). The request PRS assistance data signaling from UE to LMF can include a request for carrier aggregation based positioning, or explicit parameters for CA based PRS configuration, or a request to change the PFL group, or a request for the association between PFL.
4. Provide DL-PRS assistance data from LMF to UE: LMF provides multiple PRS PFL configurations and their association information to UE. LMF may also mark a certain PFL in PFL group as a reference PFL. For example, LMF may provide one or a list of PFL group(s) (if more than one, PFL group ID is also needed), each PRS PFL group includes two or more PRS PFLs. Multiple PRS PFL configurations belonging to the same PRS PFL group share some common parameters.

### Embodiment 2

This section discloses, among other things, another mechanism to measuring PRS measurement within a measurement gap (MG).

During a configured measurement gap, a UE can measure the DL PRS resource outside the active DL BWP or with a numerology different from the numerology of the active DL BWP if the measurement is made. UE may request a measurement gap for positioning via RRC (NR-PRS-MeasurementInfoList) or/and request the activation/deactivation of the measurement gap associated with a positioning MG ID via MAC CE. NR-PRS-MeasurementInfoList includes the request of a list of measurement gap configurations for each frequency layer. The requested measurement gap configuration includes the following parameters: dl-PRS-PointA, nr-MeasPRS-RepetitionAndOffset, nr-MeasPRS-length.

The UE may be preconfigured with one or more measurement gaps each associated with an measPosPreConfigGapId. Each is associated a set of configurations: gap offset, mgl (the measurement gap length), mgrp (the measurement gap repetition period), mgta (measurement gap timing advance (TA)), gaptype (per UE, per FR1 or per FR2). The MAC protocol for NR also supports the request of positioning measurement gap activation and deactivation from a UE.

### For UE's Measurement Gap Request:

Suppose the PRS resources aggregated from multiple PFLs are transmitted in the same slot and same symbol, only one measurement gap request signaling is needed for multiple associated PRS PFLs or one PRS PFL group. Moreover, since very likely only intra-band contiguous PFLs are supported to be aggregated, the same measurement gap type (per UE or per FR) for multiple PFLs is expected. The request signaling from UE to a network (RRC signaling to gNB or LPP signaling to LMF) can include at least one of the following information: DL-PRS point A of the reference PFL, DL-PRS point A of each PFL within one PFL group, measurement gap repetition, measurement gap offset, measurement gap length, measurement gap pattern (per-UE, per-FR)

Alternatively, UE can send the measurement gap request for each PFL, wherein the measurement gap requests for PFLs in the same PRS PFL group are associated. The measurement gap request for each PFL in PFL group may share at least one of the following common parameters: gap offset, the measurement gap length, the measurement gap repetition period, measurement gap timing advance, gap type. However, UE may request a different the timing offset of the measurement gap or the timing advance of the measurement gap for different PFLs due to their SCS are different.

If the UE is configured via LPP to measure PRS for any RSTD, PRS Reference Signal Received Power (RSRP), PRS Reference Signal Received Path Power (RSRPP) and UE Rx-Tx time difference measurement, the network provides a single per-UE measurement gap pattern or a single per-FR measurement gap pattern for concurrent monitoring of all positioning frequency layers and intra-frequency, inter-frequency and/or inter-RAT frequency layers of all frequency ranges.

### For Measurement Gap Configuration:

Collisions between occasions of two concurrent measurement gaps (e.g. one measurement gap for positioning and another measurement gap for CSI-RS) may occur. Except for positioning measurement gap ID, measurement gap repetition, measurement gap offset, measurement gap length, measurement gap TA and measurement gap pattern, gapPriority can be configured in each positioning measurement gap (pre-) configuration.

In case of collision between two measurement gap occasions, the UE shall perform measurements on the occasion of the measurement gap with higher priority, and the occasion of the measurement gap with lower priority shall be dropped.

### Embodiment 3

This section discloses, among other things, another mechanism to PRS measurement (PPW)

The UE is expected to measure the DL PRS outside the measurement gap, subject to UE capability, if the DL PRS is inside the active DL BWP and has the same numerology as the active DL BWP and is within the DL PRS processing window (PPW) indicated by higher layer parameter DL-PPW-PreConfig. For each serving cell, there is only one activated UL BWP and DL BWP. The maximum number of PPW configurations is 4 per DL BWP, and the number of activated PRS processing windows per DL BWP is 1. In addition, the maximum number of activated PRS processing windows across all active DL BWPs is 4, and currently, those activated PRS processing windows are not overlapping in time. Inside one DL-PPW-PreConfig the UE is only expected to measure a single DL PRS positioning frequency layer.

If PRS/SRS bandwidth aggregation is introduced, a UE need to simultaneously receive DL-PRS on the active DL BWP of one or multiple CCs if the DL-PRS resource is configured in multiple aggregated PFLs. UE is scheduled by a DCI or MAC CE to receive and measure DL-PRS over multiple cells in the activated PPWs.

Signaling (a DCI or a MAC CE) from gNB to UE can be used to activate/deactivate a PPW with PPW ID=i in a CC #x, another PPW with PPW ID=j in another CC #y, wherein CC #x and CC #y are associated or are in the same CC group. The association or the CC group can be configured by higher layer signaling, e.g. RRC signaling, or signaling informed by LMF. Further, the PPW ID of the associated serving cells (a group of CCs) can be the same (i.e. i=j).

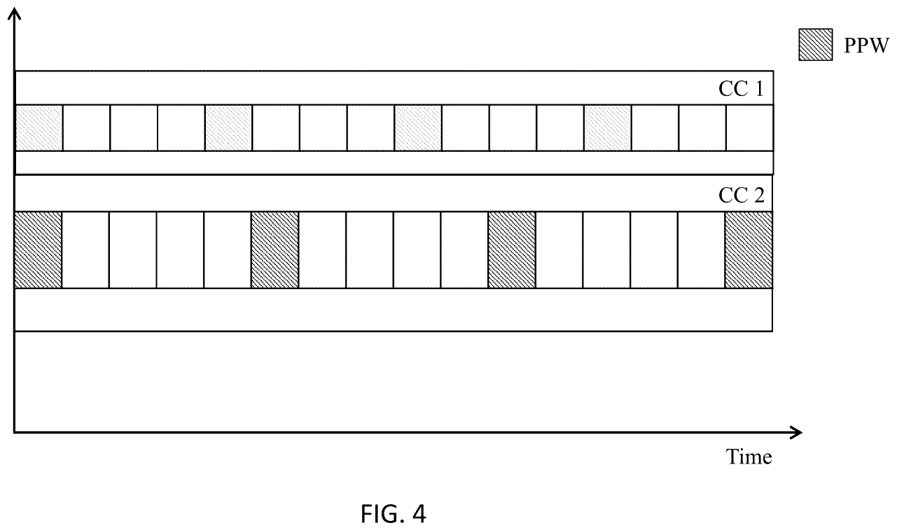

FIG. 4 shows the situation when the PPW configuration of multiple CCs are different. The periodicity of PPW in CC1 is 4 but the periodicity of PPW in CC2 is 5, in such case, the chance that UE can simultaneously receive, measure and process DL-PRS is rare.

If PPW is activated/deactivated for each CC, the PPW Activation/Deactivation Command MAC CE is specified as in FIG. 5 and FIGS. 7A-3C.

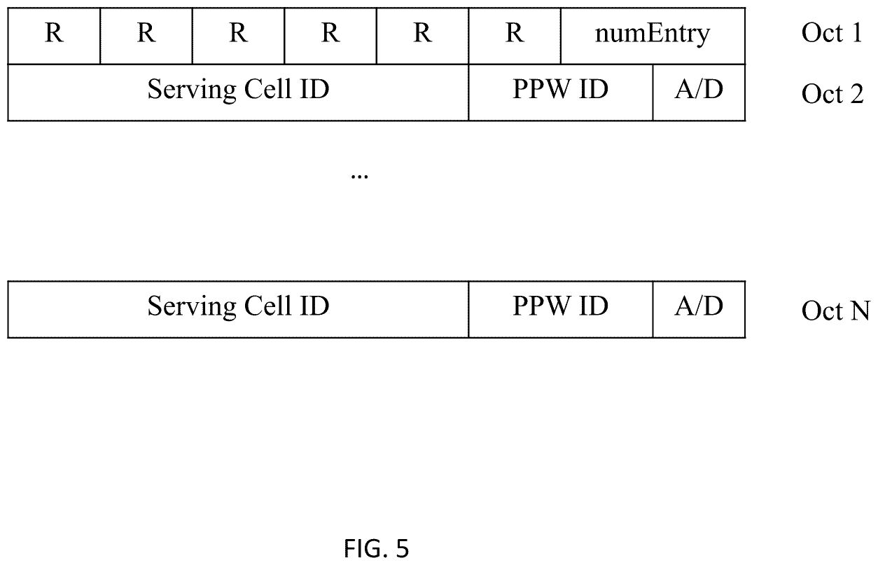

It has variable size and at least includes one of the following (as illustrated in FIG. 5):
numEntry: This field indicates the number of entries N−1 in the MAC CE. 00 indicates that N equals 2; 01 indicates that N equals 3 and so on. The length of the field is 2 bits;
Serving Cell ID: This field indicates the identity of the Serving Cell for which the MAC CE applies. The length of the field is 5 bits;
PPW ID: This field indicates the PPW configured on active DL BWP of the Serving Cell identified by the above Serving Cell ID. Index 0 corresponds to the first entry within the list of the PPW configuration in this BWP, index 1 corresponds to the second entry in the list and so on. The length of the field is 2 bits; the PPW ID can be the same for different serving cells, each associated with a serving cell ID.
A/D: This field indicates the activation or deactivation of the PPW. The field is set to 1 to indicate activation, otherwise, it indicates deactivation. The length of the field is 1 bit;
R: Reserved bit, set to 0.

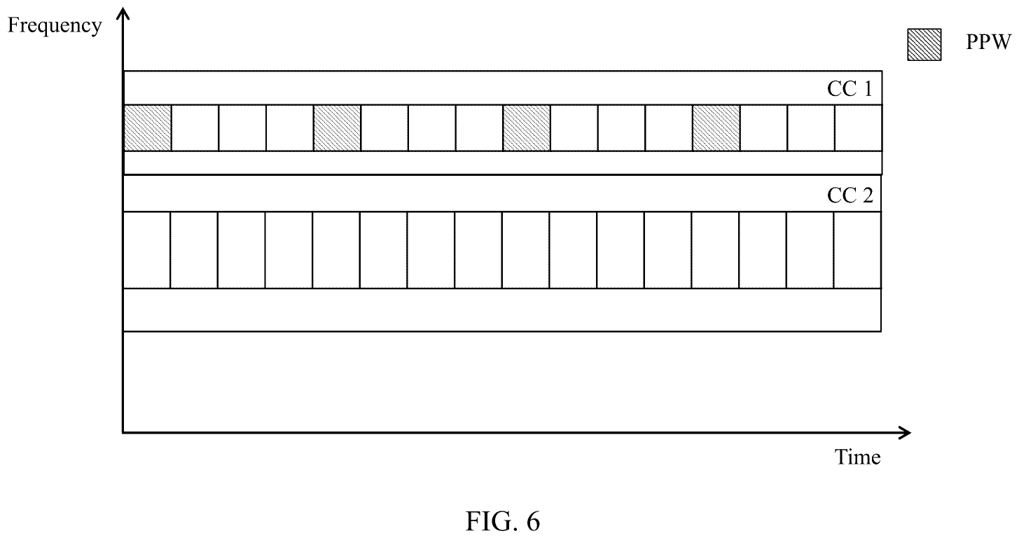

Alternatively, for the purpose of signaling overhead reduction, multiple CCs can share the same PPW configuration, which include at least one of the following: PPW ID, PPW periodicity and start slot, PPW length, PPW type and PPW priority. To be specific, the MAC CE is to activate/deactivate PPW with PPW ID=i in serving cell Cl (i.e. reference CC) associated with some serving cells or CCs as shown in FIG. 6. The association can be configured by higher layer signaling, e.g., RRC signaling, or signaling informed by LMF.

If multiple CCs share the same PPW, the PPW Activation/Deactivation Command MAC CE is specified as follows.

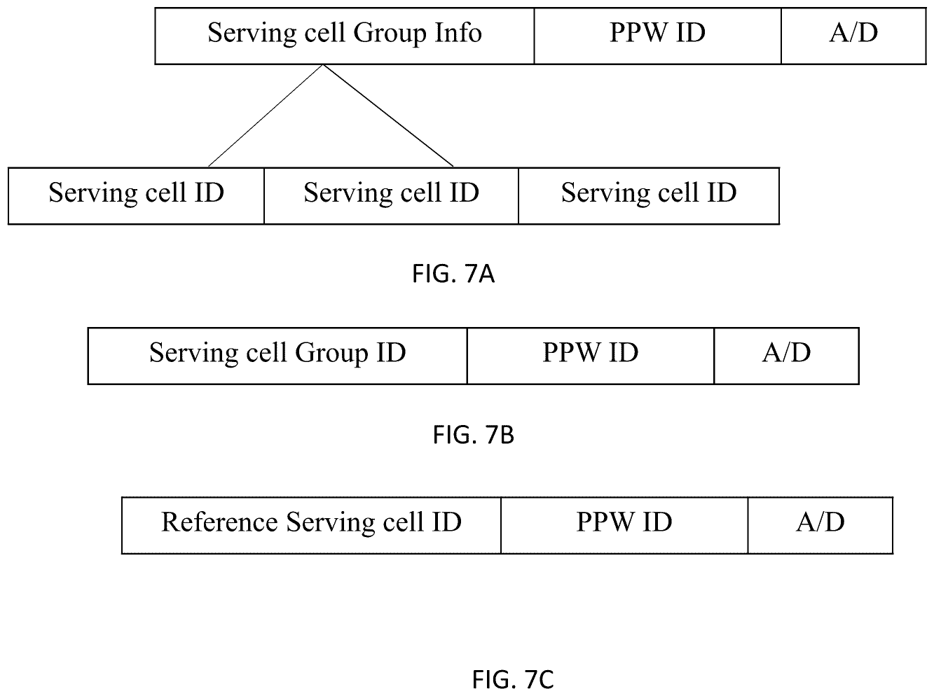

It has variable size, including at least one of the following:
1 Serving Cell group info and/or serving cell info: (1) This field indicates the identity of the Serving Cells to be aggregated in a serving cell group for which the MAC CE applies (as illustrated in FIG. 7A). The length of the field is proportional to the number of serving cells; (2) Alternatively, the serving cells for aggregation information is (pre) configured in the higher layer by gNB or LMF, the serving cells for aggregation information at least include one of: serving cell group ID, serving cell ID, reference serving cell, etc. In such case, MAC CE only need to include the serving cell group ID without mentioning every serving cell ID and thus save signaling overhead (as illustrated in FIG. 7B).
PPW ID: This field indicates the PPW configured on active DL BWP of the Serving Cells identified by the above Serving Cell group infos;
A/D: This field indicates the activation or deactivation of the PPW. The field is set to 1 to indicate activation, otherwise it indicates deactivation. The length of the field is 1 bit;

If multiple CCs share the PPW configuration (PPW ID) of the reference CC, the PPW Activation/Deactivation Command MAC CE is specified as follows.

It has variable size, including at least one of the following:
Reference Serving Cell ID: This field indicates the identity of the reference Serving Cell for which the MAC CE applies. The relationship and information of reference serving cell and other serving cells in one group to be aggregated is (pre-) configured by LMF or gNB. MAC CE only need to activate the PPW of the reference serving cell, the UE can measure the DL-PRS within the PPW if the DL-PRS is inside the multiple DL BWPs of serving cells to be aggregated. The PPW configuration is configured in the reference serving cell (as illustrated in FIG. 7C).
PPW ID: This field indicates the PPW configured on active DL BWP of the Serving Cells identified by the above Serving Cell group info.
A/D: This field indicates the activation or deactivation of the PPW. The field is set to 1 to indicate activation, otherwise, it indicates deactivation. The length of the field is 1 bit.

### Embodiment 4

This section discloses, among other things, another mechanism for PRS measurement (Frequency hopping).

For the case of frequency hopping of DL-PRS, the frequency domain resource of one reference signal is divided into several parts, each part (one part can be part of one DL-PRS resource, or DL-PRS resource within DL-PRS resource set, or DL-PRS resource set, or DL-PRS in a PFL, or DL-PRS resources of a TRP, or a DL-PRS resources of the same BWP) corresponds to a frequency hop, and several hops are received in different symbols with a combination as a whole. If different hops are associated with different BWPs/CCs/PFLs, UE may use multiple CCs to receive and measure multiple hops of DL-PRS.

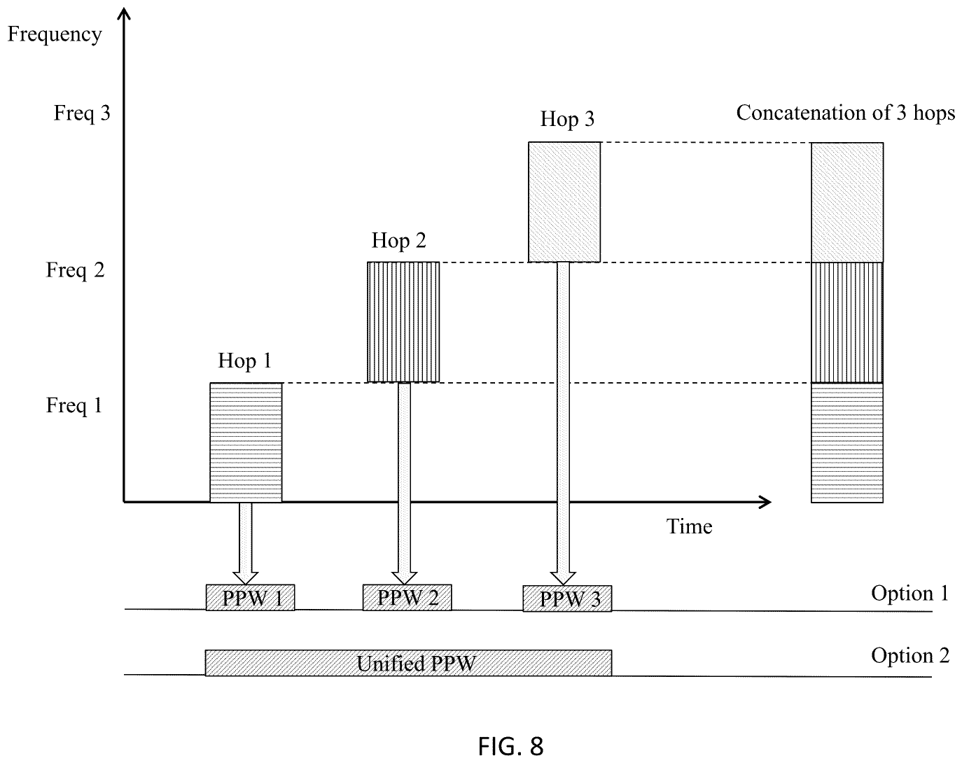

Signaling (a DCI or a MAC CE) from gNB to UE can be used to activate/deactivate a PPW with PPW ID=i in a CC #x, another a PPW with PPW ID-j in another CC #y, wherein CC #x and CC #y are associated or are in the same CC group. The association can be configured by higher layer signaling, e.g. RRC signaling, or signaling informed by LMF. Signaling (a DCI or a MAC CE) may also include DL-PRS frequency hopping related information. Further, the PPW ID of the associated serving cells (a group of CCs) is different and associated with different hopping ID. The association between the hopping ID and PPW ID can be (pre-) configured by higher layer signaling, e.g. RRC signaling, or signaling informed by LMF. The association of multiple PPW configurations can also (pre-) be configured by higher layer signaling. Specifically, at least one of the following parameters for PPW configurations associated with multiple frequency hops should be the same: PPW periodicity, the length of PPW, the priority between PDCCH/PDSCH/CSI-RS and DL-PRS, PPW type. If the periodicity of multiple PPWs is the same, the start offset (e.g., start slot) can be set differently. As shown in FIG. 8 “option 1”, PPW 1 is associated with hop 1, PPW 2 is associated with hop 2, PPW 3 is associated with hop 3.

Alternatively, multiple PPWs corresponding to different frequency hopping ID can share the same PPW ID of a reference serving cell. Up to higher layer configuration, once the PPW of a reference serving cell is activated/deactivated, automatically PPWs of other serving cells can be activated/deactivated with the same configuration (e.g., periodicity, length, type, priority) but different starting time (slot/symbol).

Alternatively, As shown in FIG. 8 “option 2”, multiple DL-PRS frequency hops may correspond to the same PPW configuration, where the time span of PPW includes all the frequency hopping occasions.

A UE is expected to measure the DL PRS within PPW if it is inside the active DL BWP and with the same numerology as the active DL BWP of the serving cell. If the numerology of different active DL BWPs of aggregated serving cells is different, the timing configuration (e.g., starting time) of PPWs is on the basis of the largest or smallest subcarrier spacing among active DL BWPs of aggregated serving cells.

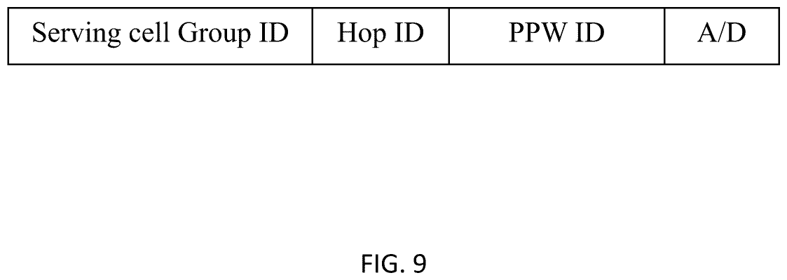

If PPW is activated/deactivated for each CC, the PPW Activation/Deactivation Command MAC CE is specified as in FIG. 9.

It has variable size defined as follows:
Serving Cell ID: This field indicates the identity of the Serving Cell for which the MAC CE applies. The length of the field is 5 bits;
1 PPW ID: This field indicates the PPW configured on active DL BWP of the Serving Cell identified by the above Serving Cell ID. Index 0 corresponds to the first entry within the list of the PPW configuration in this BWP, index 1 corresponds to the second entry in the list and so on. The length of the field is 2 bits; the PPW ID can be the same for different serving cells each associated with a serving cell ID.

Hop ID: this field indicated the DL-PRS frequency hop ID. The length of the field is related to the maximum number of DL-PRS frequency hops that gNB or LMF can configure and/or the maximum number of DL-PRS hops a UE can support.

A/D: This field indicates the activation or deactivation of the PPW. The field is set to 1 to indicate activation, otherwise, it indicates deactivation. The length of the field is 1 bit;

### Embodiment 5

This section discloses, among other things, UE capability.

The UE complexity of processing DL-PRS resource of multiple aggregated PFL will be significantly increased compared to that of processing DL-PRS of one PFL. Therefore, UE shall report capabilities corresponding to processing and measuring DL-PRS within PPW in CA scenario to LMF or gNB before LMF or gNB's DL-PRS configuration/transmission. Moreover, UE may report different capabilities for the band of different serving cells, which serving cell should be chosen as the basis of UE capability needs further study.

One solution is to report UE PRS processing capabilities outside MG and within a PRS processing window for both single PRS PFL and f aggregated PFL (of a PRS PFL group) for a band.

Supported PRS processing types subject to the UE determining that DL PRS to be a higher priority for PRS measurement outside MG and in a PRS processing window shared by multiple PFL in a PFL group, support one or more of the following:

Type 1A refers to the determination of prioritization between DL PRS and other DL signals/channels in all OFDM symbols within the PRS processing window shared by multiple PFL in a PFL group. The DL signals/channels from all DL CCs (per UE) are affected across LTE and NR

Type 1B refers to the determination of prioritization between DL PRS and other DL signals/channels in all OFDM symbols within the PRS processing window shared by multiple PFL in a PFL group. The DL signals/channels from a certain band are affected

Type 2 refers to the determination of prioritization between DL PRS and other DL signals/channels only in DL PRS symbols within the PRS processing window shared by multiple PFL in a PFL group

The ability to support different PRS processing types for multiple PFL in a PFL group, support one or more of the following:
The processing type for PRS processing windows of multiple PFLs is different.
The processing type for PRS processing windows of multiple PFLs must be the same.

Support of priority handing options of PRS outside MG and in a PRS processing window shared by multiple PFLs in a PFL group: Option1, Option2 or Option3
Option 1: Support of “st1” and “st3”
Option 2: Support of “st1”, “st2”, and “st3”
Option 3: Support of “st1”
Note:
   with value ‘st1’ where the DL PRS is higher priority than all the DL signal/channels except SSB, or
   with value ‘st2’ where the DL PRS is lower priority than PDCCH and the PDSCH scheduled by DCI formats 1_1 or 1_2 with the priority indicator field in the corresponding DCI format set to 1, and is higher priority than other DL signals/channels except SSB, or
   with value ‘st3’ where the DL PRS is lower priority than all the DL signals/channels except SSB.
      Combination of (N_{f}, T_{f}) Outside MG

Duration of DL PRS symbols N_{f} in units of ms a UE can process every T_{f} ms assuming maximum DL PRS bandwidth in MHz, which is supported and reported by UE

Duration of DL PRS symbols N_{f} 2 in units of ms a UE can process in T_{f} 2 ms assuming maximum DL PRS bandwidth in MHz, which is supported and reported by UE

The following one or more conditions should be met:

N_{f}<=N or N_{f}<N
T_{f}<=T or T_{f}<T
N_{f} 2<=N2 or N_{f} 2<N2
T_{f} 2<=T2 or T_{f} 2<T2
N_{f}=F(N, f), F(x) is a function of x, e.g. N_{f}=1/f N or N_{f}=1/f N+Δ
N_{f} 2=F(N2, f), F(x) is a function of x, e.g. N_{f} 2=1/f N2 or N_{f} 2=1/f N2+Δ
T_{f}=F(T, f), F(x) is a function of x, e.g. T_{f}=1/f T or T_{f}=1/f T+Δ
T_{f} 2=F(T2, f), F(x) is a function of x, e.g. T_{f} 2=1/f T2 or T_{f} 2=1/f T2+Δ
   Max Number of DL PRS Resources that UE can Process in a Slot Outside MG
Max number of DL PRS resources in different frequency layers simultaneously that UE can process in a slot outside MG is less than that in one frequency layer.
   Maximum DL PRS Bandwidth in MHz, which is Supported and Reported by UE for PRS Measurement Outside MG within the PPW
This parameter is larger than the maximum DL-PRS bandwidth for PRS measurement in one PFL outside MF within PPW
This parameter is highly related or proportional to the maximum number of PFL for carrier aggregation that UE supports
This parameter includes the gap length between two frequency layers.

### Timing Shift or Phase Shift Among Different CCs

When UE receive DL-PRS within PPW in different CCs, UE may report its supported minimum or maximum timing/phase shift, UE may also report different timing/phase shift for different CC/serving cell/PRS-bandwidth

### Embodiment 6

This section discloses, among other things, measurement period requirements.

When the physical layer receives last of NR-TDOA-Provide Assistance Data message and NR-TDOA-RequestLocationInformation message from LMF via LPP, the UE shall be able to measure multiple (up to the UE capability) DL RSTD measurements, defined in TS 38.215, during the measurement period T_{RSTD,Total} defined as:

$${T}_{RSTD , Total} = {\sum }_{i = 1}^{L} {T}_{RSTD , i} + ( L - 1 ) * max ( {T}_{effect , i} )$$

where:
i is the index of the positioning frequency layer,
L is total number of positioning frequency layers, and
T_{effect,i} is the periodicity of the PRS RSTD measurement in positioning frequency layer i

On positioning frequency layer i within active BWP during the measurement period T_{RSTD,i} defined as:

$${T}_{RSTD \_ wo \_ gap , i} = ( {k}_{multiTEG , i} * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} ,$$

where:
N_{RxBeam,i} is the UE Rx beam sweeping factor.
k_{multiTEG,i} is the scaling factor for measurement of same PRS resource with multiple Rx TEGs.
N_{PRS,i}^{slot} is the maximum number of DL PRS resources in positioning frequency layer i configured in a slot.
L_{available_PRS,i} is the time duration of available PRS in the positioning frequency layer i to be measured during T_{available_PRS,i}, and is calculated in the same way as PRS duration K defined in clause 5.1.6.5 of TS 38.214. For calculation of L_{available_PRS,i}, only the PRS resources unmuted and fully or partially overlapped with PPW are considered.
Nₛₐₘₚₗₑ is the number of PRS RSTD measurement samples, where
T_{last,i} is the measurement duration for the last PRS RSTD sample in positioning frequency layer i, including the sampling time and processing time, T_{last,i}=Tᵢ+T_{available_PRS,i}
T_{effect,i} is the periodicity of the PRS RSTD measurement in positioning frequency layer i defined as:

$${T}_{effect , i} = ⌈ \frac{{T}_{i}}{{T}_{available \_ PRS , i}} ⌉ * {T}_{available \_ PRS , i}$$

### Where,

Tᵢ corresponds to ppw-durationOfPRS-ProcessingSymbolsT in TS 37.355,
T_{available_PRS,i}=LCM (T_{PRS,i},PPWRPᵢ), the least common multiple between T_{PRS,i} and PPWRPᵢ.
PPWRPᵢ is the repetition periodicity of the PRS processing window applicable for measurements in the positioning frequency layer i.
T_{PRS,i} is the periodicity of DL PRS resource with muting on positioning frequency layer i.
   If more than one PRS periodicities are configured in positioning frequency layer i, the least common multiple of PRS periodicities Tₚₑᵣ^{PRS with muting} among all DL PRS resource sets in the positioning frequency layer is used to derive T_{PRS,i}, where,
Tₚₑᵣ^{PRS with muting}=N_{muting}*Tₚₑᵣ^{PRS}, is the PRS periodicity with muting per PRS resource,

Tₚₑᵣ^{PRS} is the periodicity of PRS resource sets given by the higher-layer parameter DL-PRS-Periodicity,
N_{muting} is the scaling factor considering PRS resource muting. N_{muting}=T_{muting}^{PRS}*L_{muting}, where T_{muting}^{PRS} is the muting repetition factor given by the higher-layer parameter DL-PRS-MutingBitRepetitionFactor, and L_{muting} is the size of the bitmap {b¹}.

When the physical layer receives NR-DL-AoD-ProvideAssistance Data message and NR-DL-AoD-RequestLocationInformation message from LMF via LPP, the UE shall be able to measure multiple (up to the UE capability) PRS-RSRP measurements as defined in TS 38.215 without measurement gap, from configured PRS resources for configured TRPs on configured positioning frequency layers, within T_{PRS-RSRP,total} ms.

$${T}_{PRS - RSTD , total} = {\sum }_{i = 1}^{L} {T}_{PRS - RSTD , i} + ( L - 1 ) * max ( {T}_{effect , i} )$$

On configured positioning frequency layer i, within T_{PRS-RSRP,i} defined as:

$${T}_{PRS - RSTD \_ wo \_ gap , i} = ( {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last}$$

For PRS measurement without MG configured to UE, measurement period requirements for PRS-RSRP is re-used for PRS-RSRPP.

When physical layer receives last of NR-Multi-RTT-Provide AssistanceData message and NR-Multi-RTT-RequestLocationInformation message from LMF via LPP, UE shall be able to measure multiple (up to the UE capability) UE Rx-Tx time difference measurements as defined in TS 38.215 in configured positioning frequency layers within the measurement period T_{UERxTx,Total} ms.

$${T}_{UERxTx , Total} = {\sum }_{i = 1}^{L} {T}_{UERxTx , i} + ( L - 1 ) * max ( {T}_{effect , i} ) .$$

in configured positioning frequency layer i within the measurement period T_{UERxTx_wo_gap,i}.

$${T}_{UERxTx \_ wo \_ gap , i} = ( {k}_{multiTEG , i} * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} ,$$

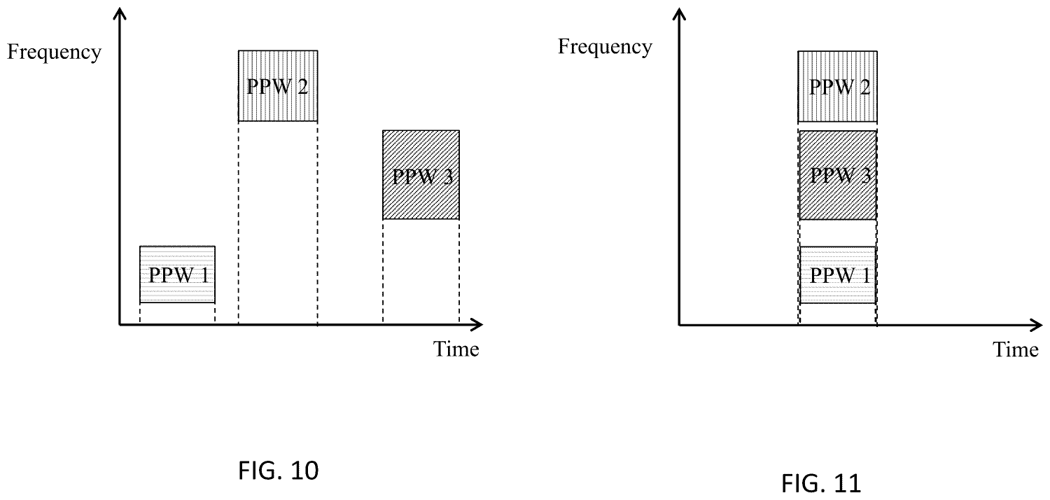

As shown at the beginning of this embodiment, the measurement period for positioning is calculated on the basis of PFL (i is the index of PFL). Inside one PPW config or positioning measurement gap config the UE is only expected to measure a single DL-PRS PFL. As shown in FIG. 10, different positioning MG or activated PPW is not overlapping in the time domain.

However, as shown in FIG. 11, in CA scenario DL-PRS RSTD/RSRP/RSRPP/Rx-Tx time difference, are not measured separately on multiple aggregated PFL, PFL as the basis of calculating the measurement period may not be very appropriate and accurate.

The measurement period of DL-PRS measured simultaneously in multiple PFLs should be no smaller or larger than that of DL-PRS measured in one PFL but no larger than or smaller than the sum of the measurement period of multiple PFLs.

In the following paragraphs, we provide 2 solutions:

### Solution 1

For the period of multiple aggregated frequency layers positioning measurement, L₁ aggregated PFLs can be regarded as one PFL due to DL-PRS are simultaneously received and measured in L₁ aggregated PFLs. The measurement period requirement of a referent PFL (r) can be used as the reference of other PFLs' measurement period requirement in the same group.

$${T}_{RSTD , Total} = S * {L}_{1} * {T}_{RSTD , r} + {\sum }_{i = 1}^{{L}_{2}} {T}_{RSTD , i} + ( L - 1 ) * max ( {T}_{effect , i} )$$

$${T}_{PRS - RSTD , Total} = S * {L}_{1} * {T}_{PRS - RSTD , r} + {\sum }_{i = 1}^{{L}_{2}} {T}_{PRS - RSTD , i} + ( L - 1 ) * max ( {T}_{effect , i} )$$

$${T}_{PRS - RSRPP , Total} = S * {L}_{1} * {T}_{PRS - RSRPP , r} + {\sum }_{i = 1}^{{L}_{2}} {T}_{PRS - RSRPP , i} + ( L - 1 ) * max ( {T}_{effect , i} )$$

$${T}_{UERxTx , Total} = S * {L}_{1} * {T}_{UERxTx , r} + {\sum }_{i = 1}^{{L}_{2}} {T}_{UERxTx , i} + ( L - 1 ) * max ( {T}_{effect , i} )$$

Where L is the total number of positioning frequency layers, L=L₁+L₂
L₁ is the number of positioning frequency layers which used for bandwidth/carrier aggregation.
L₂ is the total number of PFLs minus the number of PFLs which used for bandwidth/carrier aggregation.

A scaling factor S can be introduced since the complexity of UE simultaneously measuring DL-PRS in multiple aggregated PFLs is larger than the complexity of UE measuring DL-PRS in one PFL. S≤1 or S<1

Alternatively, the scaling factor SL, is larger than 1 and associated with the number of positioning frequency layers used for bandwidth/carrier aggregation.

$${T}_{RSTD , Total} = {S}_{{L}_{1}} * {T}_{RSTD , r} + {\sum }_{i = 1}^{{L}_{2}} {T}_{RSTD , i} + ( L - 1 ) * max ( {T}_{effect , i} )$$

$${T}_{PRS - RSTD , Total} = {S}_{{L}_{1}} * {T}_{PRS - RSTD , r} + {\sum }_{i = 1}^{{L}_{2}} {T}_{PRS - RSTD , i} + ( L - 1 ) * max ( {T}_{effect , i} )$$

$${T}_{PRS - RSRPP , Total} = {S}_{{L}_{1}} * {T}_{PRS - RSRPP , r} + {\sum }_{i = 1}^{{L}_{2}} {T}_{PRS - RSRPP , i} + ( L - 1 ) * max ( {T}_{effect , i} )$$

$${T}_{UERxTx , Total} = {S}_{{L}_{1}} * {T}_{UERxTx , r} + {\sum }_{i = 1}^{{L}_{2}} {T}_{UERxTx , i} + ( L - 1 ) * max ( {T}_{effect , i} )$$

Alternatively, an offset Δ_{L}_{₁} can be introduced for the equation of measurement period (e.g. T_{RSTD,Total}, T_{PRS-RSRP,Total}, T_{PRS-RSRPP,Total}, T_{UERxTx,Total}). The measurement period of L₁ frequency layers to be aggregated is larger than that of the reference frequency layer with an offset added. Moreover, the offset Δ_{L}_{₁} is associated with the number of positioning frequency layers used for bandwidth/carrier aggregation. The larger the L₁ value, the larger the offset, and thus the larger the measurement period. For example, Δ_{L}_{₁}=Δ*L₁, 0<Δ≤1 or 0<Δ<1

$${T}_{RSTD , Total} = {T}_{RSTD , r} + {\sum }_{i = 1}^{{L}_{2}} {T}_{RSTD , i} + ( L - 1 ) * max ( {T}_{effect , i} ) + {Δ}_{{L}_{i}}$$

$${T}_{PRS - RSTD , Total} = {T}_{PRS - RSTD , r} + {\sum }_{i = 1}^{{L}_{2}} {T}_{PRS - RSTD , i} + ( L - 1 ) * max ( {T}_{effect , i} ) + {Δ}_{{L}_{i}}$$

$${T}_{PRS - RSRPP , Total} = {T}_{PRS - RSRPP , r} + {\sum }_{i = 1}^{{L}_{2}} {T}_{PRS - RSRPP , i} + ( L - 1 ) * max ( {T}_{effect , i} ) + {Δ}_{{L}_{i}}$$

$${T}_{UERxTx , Total} = {T}_{UERxTx , r} + {\sum }_{i = 1}^{{L}_{2}} {T}_{UERxTx , i} + ( L - 1 ) * max ( {T}_{effect , i} ) + {Δ}_{{L}_{i}}$$

Either scaling factor or offset, or both scaling factor and offset can be introduced in the measurement period equation based on the reference frequency layer.

### Solution 2

The design of measurement period requirement formula should separately consider the measurements conducted in aggregated PFLs and measurements conducted in other PFLs not used for carrier aggregation.

For the measurement conducted in aggregated PFLs, a carrier-specific scaling factor for PRS measurement can be introduced. As shown in the following formulas, the calculation of measurement period requirement is separated by L₁ and L₂.

$${T}_{RSRD , Total} = {\sum }_{i = 1}^{{L}_{1}} {T}_{RSRD , i} + ( {L}_{1} - 1 ) * max ( {T}_{effect , i} ) + {\sum }_{i = 1}^{{L}_{2}} {T}_{RSRD , i} + ( {L}_{2} - 1 ) * max ( {T}_{effect , i} ) or {T}_{RSRD , Total} = {\sum }_{i = 1}^{{L}_{1}} {T}_{RSRD , i} + {\sum }_{i = 1}^{{L}_{2}} {T}_{RSRD , i} + ( L - 1 ) * max ( {T}_{effect , i} ) ,$$

$${T}_{PRS - RSRP , Total} = {\sum }_{i = 1}^{{L}_{1}} {T}_{PRS - RSRP , i} + ( {L}_{1} - 1 ) * max ( {T}_{effect , i} ) + {\sum }_{i = 1}^{{L}_{2}} {T}_{PRS - RSRP , i} + ( {L}_{2} - 1 ) * max ( {T}_{effect , i} ) or {T}_{PRS - RSRP , Total} = {\sum }_{i = 1}^{{L}_{1}} {T}_{PRS - RSRP , i} + {\sum }_{i = 1}^{{L}_{2}} {T}_{PRS - RSRP , i} + ( L - 1 ) * max ( {T}_{effect , i} ) ,$$

$${T}_{PRS - RSRPP , Total} = {\sum }_{i = 1}^{{L}_{1}} {T}_{PRS - RSRPP , i} + ( {L}_{1} - 1 ) * max ( {T}_{effect , i} ) + {\sum }_{i = 1}^{{L}_{2}} {T}_{PRS - RSRPP , i} + ( {L}_{2} - 1 ) * max ( {T}_{effect , i} ) or {T}_{PRS - RSRPP , Total} = {\sum }_{i = 1}^{{L}_{1}} {T}_{PRS - RSRPP , i} + {\sum }_{i = 1}^{{L}_{2}} {T}_{PRS - RSRPP , i} + ( L - 1 ) * max ( {T}_{effect , i} ) ,$$

$${T}_{UERxTx , Total} = {\sum }_{i = 1}^{{L}_{1}} {T}_{UERxTx , i} + ( {L}_{1} - 1 ) * max ( {T}_{effect , i} ) + {\sum }_{i = 1}^{{L}_{2}} {T}_{UERxTx , i} + ( {L}_{2} - 1 ) * max ( {T}_{effect , i} ) or {T}_{UERxTx , Total} = {\sum }_{i = 1}^{{L}_{1}} {T}_{UERxTx , i} + {\sum }_{i = 1}^{{L}_{2}} {T}_{UERxTx , i} + ( L - 1 ) * max ( {T}_{effect , i} ) ,$$

Where L is the total number of positioning frequency layers, L=L₁+L₂
L₁ is the number of positioning frequency layers which used for bandwidth/carrier aggregation.
L₂ is the total number of PFLs minus the number of PFLs which used for bandwidth/carrier aggregation.
   For Measurement Period Requirement without MG:

For measurement period requirement for multiple PFLs within multiple activated PPWs, a carrier specific scaling factor for PRS measurement can be introduced, e.g. CSSF_{PRS_within_PPW,i}. The measurement period requirement formula without MG for RSTD T_{RSTD,i}, RSRP T_{PRS-RSRP,i} and RSRPP T_{PRS-RSRPP,i}, Rx-Tx time difference T_{UERxTx,i} measurements respectively are shown as below:

$${T}_{RSTD \_ wo \_ gap , i} = ( {CSSF}_{PRS \_ within \_ , i} * {k}_{multiTEG , i} * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} i = 1 {…L}_{1} ,$$

$${T}_{PRS - RSTD \_ wo \_ gap , i} = ( {CSSF}_{PRS \_ within \_ , i} * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last} i = 1 {…L}_{1} ,$$

$${T}_{UERxTx \_ wo \_ gap , i} = ( {CSSF}_{PRS \_ within \_ , PPW , i} * {k}_{multiTEG , i} * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} i = 1 {…L}_{1} ,$$

When multiple positioning frequency layers are configured,
for each positioning frequency layer i, CSSF_{PRS_within_PPW,i} is derived with the following steps assuming no other positioning frequency layer is configured.
for each RRM frequency layer i, CSSF_{PRS_within_PPW,i} is derived as follows:
   an intermediate CSSF_{PRS_within_PPW,i,k} is derived with the following steps assuming only positioning frequency layer k is configured, and
   CSSF_{PRS_within_PPW,i}=max(CSSF_{PRS_within_PPW,i,k}), where k=0 . . . K−1, and K is the number of configured positioning frequency layers.

CSSF_{PRS_within_PPW,i} is associated with the number of NR inter positioning frequency layers and Rᵢ, where Rᵢ is the maximal ratio of the number of PPW where measurement object i is a candidate to be measured over the number of PPW where measurement object i is a candidate and not used for a long-periodicity measurement.

L_{available_PRS,i} is the time duration of available PRS in the positioning frequency layer i to be measured during T_{available_PRS,i}, and is calculated in the same way as PRS duration K defined in clause 5.1.6.5 of TS 38.214. For calculation of L_{available_PRS,i}, if multiple PFL share the same PPW configuration, only the PRS resources unmuted and fully or partially overlapped with PPW are considered. If each PFL is associated with one PPW configuration and multiple PFL or PPW configurations are associated, only the PRS resources unmuted and fully or partially overlapped with the common part of multiple PPWs are considered.

T_{available_PRS,i}=LCM(T_{PRS,i},PPWRPᵢ), the least common multiple between T_{PRS,i} and PPWRPᵢ.

PPWRPᵢ is the repetition periodicity of the PRS processing window applicable for measurements in the positioning frequency layer i if multiple PFL share the same PPW configuration (frequency layer i is the reference frequency layer). PPW RP; is the least common multiple of multiple repetition periodicity of the PRS processing window applicable for measurements in the positioning frequency layer group if each PFL is associated with one PPW configuration and multiple PFL or PPW configurations are associated.

T_{PRS,i} is the periodicity of DL PRS resource with muting on positioning frequency layer i.

If each PFL is associated with one PPW configuration and multiple PFL or PPW configurations are associated, the time T_{RSTD_wo_gap,i}, T_{PRS-RSRP_wo_gap,i}, T_{UERxTx_wo_gap,i} starts from the first instance of the activated PPW for measurement of positioning frequency layer i or the first overlapped instance of the activated PPWs aligned with a DL PRS resource(s) in the assistance data after both the NR-TDOA-ProvideAssistanceData message and NR-TDOA-RequestLocationInformation message are delivered from LMF to the physical layer of UE via LPP.

If multiple PFL share the same PPW configuration, the time T_{RSTD_wo_gap,i}, T_{PRS-RSRP_wo_gap,i}, T_{UERxTx_wo_gap,i} starts from the first instance of the activated PPW for measurement of the reference positioning frequency layer.

One frequency layer of multiple frequency layers to be aggregated can be a reference frequency layer for calculate T_{RSTD_wo_gap}, T_{PRS-RSRP_wo_gap}, T_{PRS-RSRPP_wo_gap}, T_{UERxTx_wo_gap}

### Embodiment 7

This section discloses, among other things, examples of SRS configuration

As we mentioned above, bandwidth is essential to positioning accuracy. SRS for positioning purposes (we will use SRS in the following paragraphs for simplicity) transmitted among multiple CCs simultaneously will significantly enlarge the bandwidth of SRS resources and thus be beneficial for positioning accuracy. First of all, multiple BWP, wherein each belongs to a CC/carrier/cell, can be configured and simultaneously activated by a single signaling (DCI, RRC or gNB can set a timer so that multiple BWPs is activated at the same time).

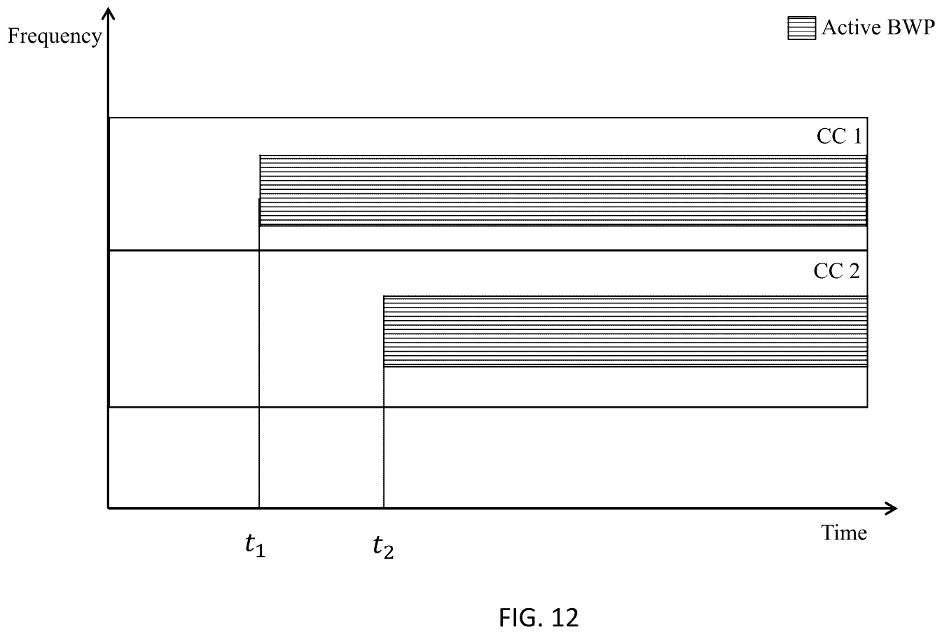

If multiple BWP belonging to a CC/carrier/cell are not activated simultaneously, gNB should make sure the scheduling of SRS happens when all the corresponding BWPs are activated. For example, as shown in FIG. 12, the scheduling of SRS transmission should not be earlier than t₂.

A single scheduling grant (DCI for dynamic scheduling and MAC CE for semi-persistent scheduling) can schedule SRS resources or SRS resource sets from multiple CCs, where the SRS resources are transmitted simultaneously in multiple CCs.

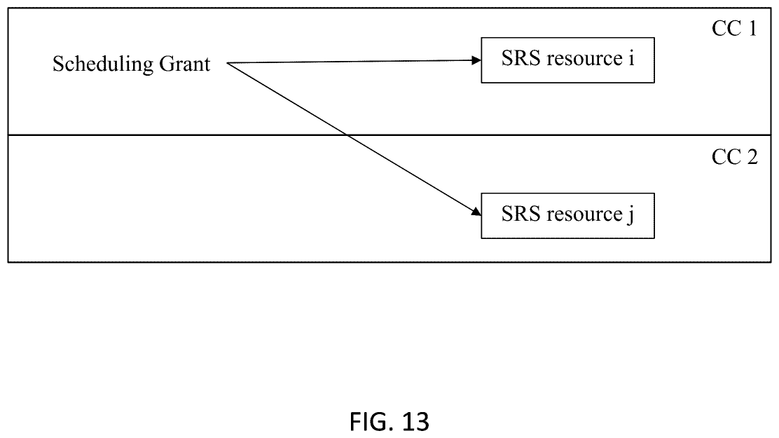

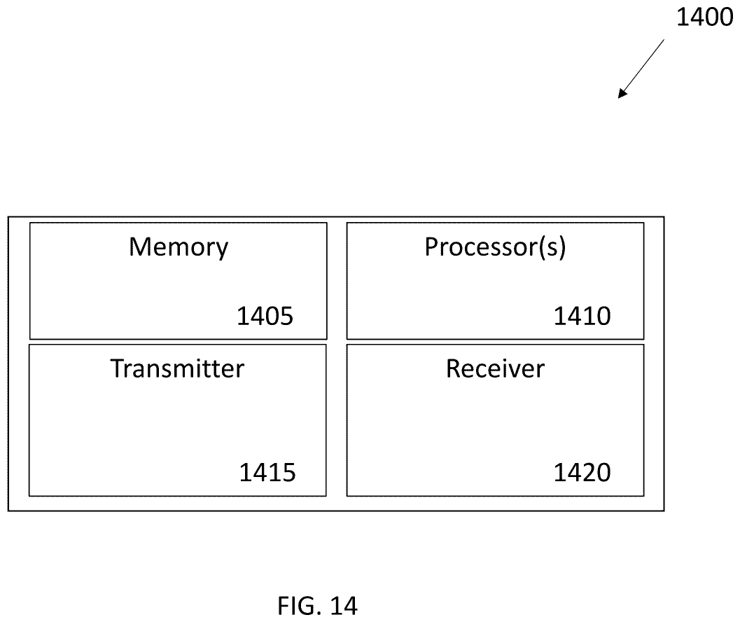

Specifically, as shown in FIG. 13, one signaling (a DCI or a MAC CE) can be used to schedule a SRS resource with resource ID=i or resource set with resource set ID=i in a CC #1, another positioning RS resource with resource ID-j or resource set with resource set ID=j is also scheduled in another CC #2, wherein CC #1 and CC #2 are associated or are in the same CC group.

Specifically, Multiple SRS resources and/or resource set configurations belonging to the same CC group share some common parameters, the common parameters include at least one or more of the following: SRS resource set ID, SRS resource ID, SRS resource ID list, resource type (aperiodic, semi-persistent, periodic), alpha value for SRS power control, p0 value for SRS power control, pathloss reference RS (SSB, DL-PRS), number of SRS port, transmission comb size, comb offset, cyclic shift, resource mapping (start position, number of symbols), frequency domain shift, frequency hopping, group or sequency hopping, sequence ID, spatial relation information (serving cell RS, SSB, DL-PRS)

The SRS resource ID or resource set ID scheduled by the signaling of multiple CCs can be the same. The BWP ID of multiple CCs are associated or can be the same and activated simultaneously.

Furthermore, the timing offset between the triggering grant (DCI or MAC CE) and the actual transmission of SRS resources can be included in the configuration via RRC from gNB or signaling from LMF and further transmitted to UE via the scheduling grant. Due to the configuration inconsistent (e.g. SCS or timing set) of different CCs, the timing offset is based on the SCS of all the CCs involved in the aggregated SRS transmission (at least one of the: the maximum SCS or the minimum SCS of the CCs in a group).

FIG. 14 shows an exemplary block diagram of a hardware platform 1400 that may be a part of a network device (e.g., base station) or a communication device (e.g., user equipment (UE)). The hardware platform 1400 includes at least one processor 1410 and a memory 1405 having instructions stored thereupon. The instructions upon execution by the processor 410 configure the hardware platform 1400 to perform the operations described in FIG. 14 and in the various embodiments described in this patent application document. The transmitter 1415 transmits or sends information or data to another device. For example, a network device transmitter can send a message to user equipment. The receiver 1420 receives information or data transmitted or sent by another device. For example, user equipment can receive a message from a network device.

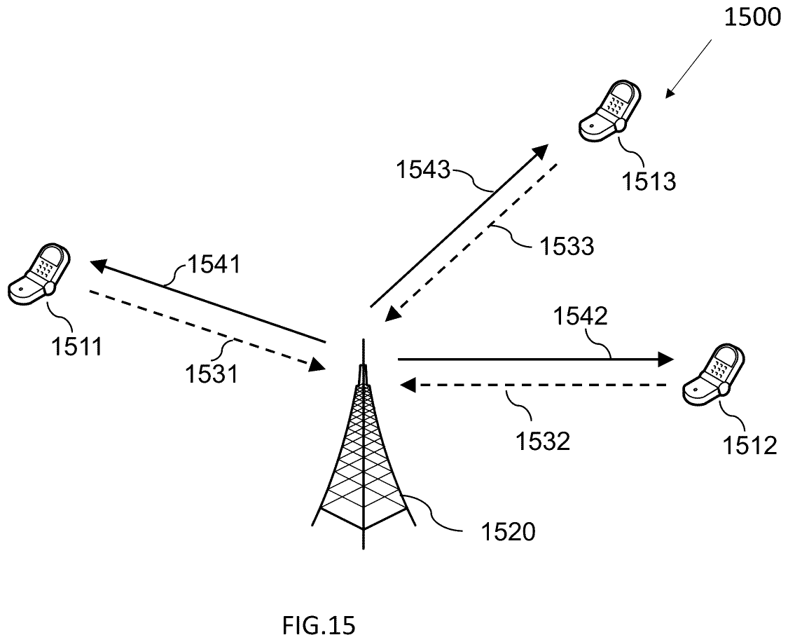

The implementations as discussed above will apply to a network communication. FIG. 15 shows an example of a communication system (e.g., a 6G or NR cellular network) that includes a base station 1520 and one or more user equipment (UE) 1511, 1512 and 1513. In some embodiments, the UEs access the BS (e.g., the network) using a communication link to the network (sometimes called uplink direction, as depicted by dashed arrows 1531, 1532, 1533), which then enables subsequent communication (e.g., shown in the direction from the network to the UEs, sometimes called downlink direction, shown by arrows 1541, 1542, 1543) from the BS to the UEs. In some embodiments, the BS send information to the UEs (sometimes called downlink direction, as depicted by arrows 1541, 1542, 1543), which then enables subsequent communication (e.g., shown in the direction from the UEs to the BS, sometimes called uplink direction, shown by dashed arrows 1531, 1532, 1533) from the UEs to the BS. The UE may be, for example, a smartphone, a tablet, a mobile computer, a machine to machine (M2M) device, an Internet of Things (IoT) device, and so on.

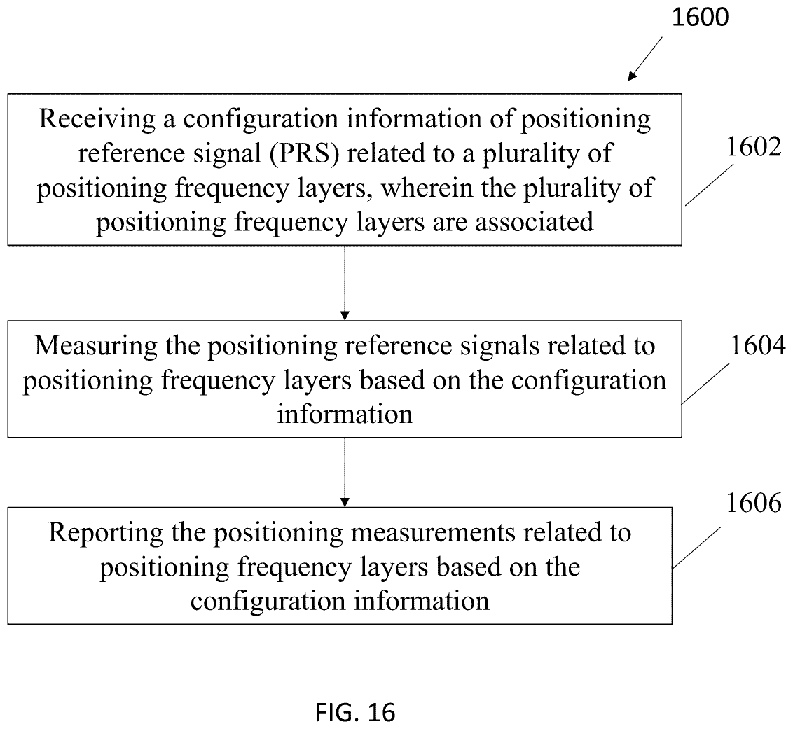

In one example aspect (e.g., as depicted in FIG. 16), a wireless communication method is disclosed. The method receiving (1602), by a wireless device, from a network device, a configuration information of positioning reference signal (PRS) related to a plurality of positioning frequency layers, wherein the plurality of positioning frequency layers are associated; measuring (1604), by the wireless device, the positioning reference signal related to positioning frequency layers based on the configuration information; and reporting (1606), by the wireless device to a network device, the positioning measurements related to positioning frequency layers based on the configuration information.

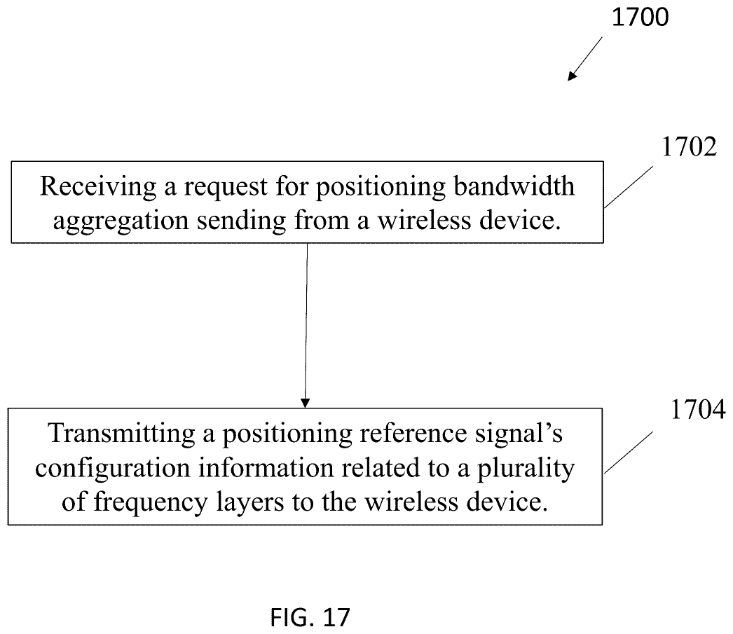

In another example aspect (e.g., as depicted in FIG. 17), another wireless communication method is disclosed. The method includes receiving (1702), by a network device, a request for a configuration information of positioning reference signal (PRS) sending from a wireless device; and transmitting (1704), by the network device, a positioning reference signal's configuration information related to a plurality of frequency layers to the wireless device.’

In some embodiments, the configuration information is determined based on an signaling interactions between the network device and a second network device.

In some embodiments, the configuration information comprises information related to at least one frequency layer group.

In some embodiments, the request sent from the wireless device to the network device, wherein the request comprises at least one of 1) a request for bandwidth aggregation based positioning, or 2) explicit parameters for bandwidth aggregation-based PRS configuration or 3) a request to change a frequency layer group 4) a request for an association between frequency layers.

In some embodiments, each frequency layer group comprises at least one frequency layer, wherein the frequency layers within a frequency layer group share at least one of common feature: Subcarrier Spacing (SCS); an identifier (ID) for Transmission-Reception Point (TRP); antenna reference point (ARP); PRS resource set ID; PRS resource ID; PRS periodicity; PRS resource slot offset; PRS resource repetition factor; time gap; muting pattern; PRS symbol number; PRS resource slot offset, PRS resource symbol offset; PRS comb size and RE offset; PRS sequence ID; PRS Quasi Co Location (QCL) info; PRS transmission power; PRS expected reference signal time difference (RSTD) and expected RSTD uncertainty. In other embodiments, each frequency layer group may comprise at least two frequency layers.

In some embodiments, each frequency layer within a frequency layer group has at least one parameter with a unique value of its own.

In some embodiments, the configuration information of a plurality of positioning frequency layers is associated with a reference frequency layer's configuration information.

In some embodiments, the configuration information comprises a bandwidth information that is associated with a value representing a maximum bandwidth configured for one frequency layer and a number representing the maximum number of bandwidths to be aggregated.

In some embodiments, the measuring is based on a plurality of signals received from a second network device, wherein each of the signals correspond to one of the plurality of frequency layers.

In some embodiments, each signal is measured in a positioning measurement gap, wherein the measurement gap (pre-) configuration information comprises a priority parameter

In some embodiments, the measurement gap is configured with an assistance of a request from the wireless device, wherein only one measurement gap request signaling is needed for one positioning frequency layer group.

In some embodiments, the measuring is based on a signaling from a second network device, wherein the signaling includes an identity information of a plurality of positioning processing windows (PPW) in different serving cells.

In some embodiments, each serving cell of the plurality of serving cells have one activated positioning processing window, wherein those activated positioning processing windows share a same positioning processing window configuration.

In some embodiments, an association of the different serving cells is configured by the network device or the second network device via high layer signaling

In some embodiments, the plurality of serving cells share a positioning processing window configuration of a reference serving cell's activated positioning processing window

In some embodiments, the positioning processing window is activated and deactivated via a Medium Access Control element (MAC CE) signaling, wherein the MAC CE signaling comprises at least one of serving cell identity, serving cell group identity, positioning processing window identity, reference serving cell identity.

In some embodiments, measuring is based on a signal from a second network device, wherein the signal comprises a plurality of first identity information and a plurality of second identify information, wherein the first identify information is related to the second identify information based on a relationship.

In some embodiments, the relationship is configured by a higher layer node and sent to the wireless device.

In some embodiments, the plurality of first identity information is associated with a same positioning processing window configuration that is at least one of: 1) a positioning processing window (PPW) periodicity, 2) length of PPW, 3) a priority between Physical Downlink Control Channel (PDCCH)/Physical Downlink Shared Channel (PDSCH)/Channel State Information Reference Signal (CSI-RS) and Downlink Positioning Reference Signal (DL-PRS), or 4) a PPW type.

In some embodiments, the above methods further comprising, transmitting a capability information to the network device or a second network device.

In some embodiments, where in the capability information comprises at least one of: an ability to measure and process positioning reference signals resources from multiple frequency layers in a frequency layer group within PPW, or an ability to measure and process positioning reference signals resources from one frequency layer within PPW

In some embodiments, the capability information comprises PPW processing type shared by multiple frequency layers in a frequency layer group.

In some embodiments, the capability information comprises PPW priority handing options shared by multiple frequency layers in a frequency layer group.

In some embodiments, the capability information comprises a max number of PRS resources the wireless device can process in a time range.

In some embodiments, the capability information comprises a maximum bandwidth supported and reported by the wireless device.

In some embodiments, the capability information comprises a time shift or phase shift among different serving cells.

In some embodiments, the measuring is completed within a period corresponding to the plurality of frequency layers.

In some embodiments, measurement period of measuring PRS from one frequency layer group is not smaller than that of measuring PRS from one frequency layer and not larger than a sum of measurement period of measuring PRS from each frequency layer

In some embodiments, the period is determined based on a measurement period of a reference frequency layer.

In some embodiments, either/both a scaling factor or/and an offset associated with the number of frequency layers can be used for an equation of measurement period requirement.

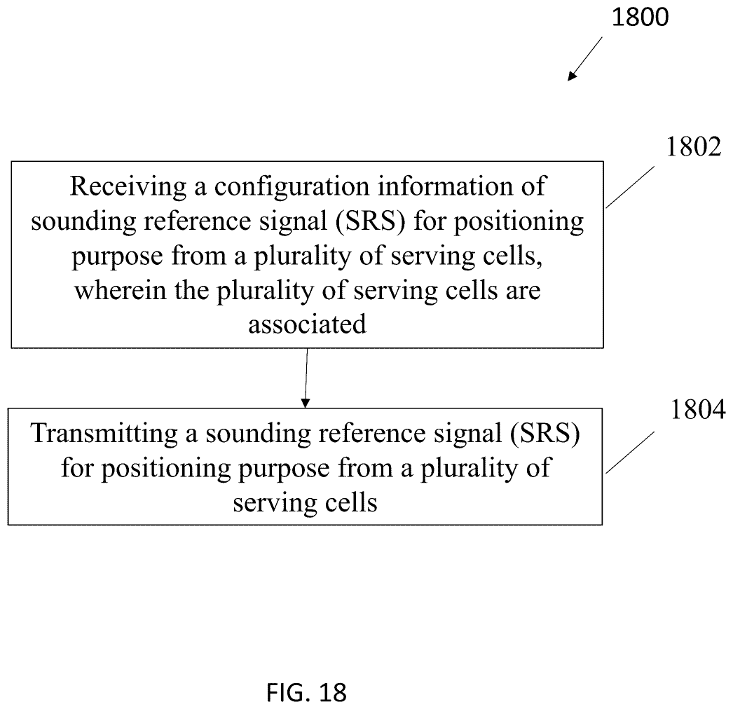

In one example aspect (e.g., as depicted in FIG. 18), a wireless communication method is disclosed. The method includes receiving (1802), by a wireless device from a network device, a configuration information of sounding reference signal (SRS) for positioning purpose in a plurality of serving cells, wherein the plurality of serving cells are associated; and transmitting (1804), by a wireless device to a network device, a sounding reference signal (SRS) for positioning purpose in a plurality of serving cells.

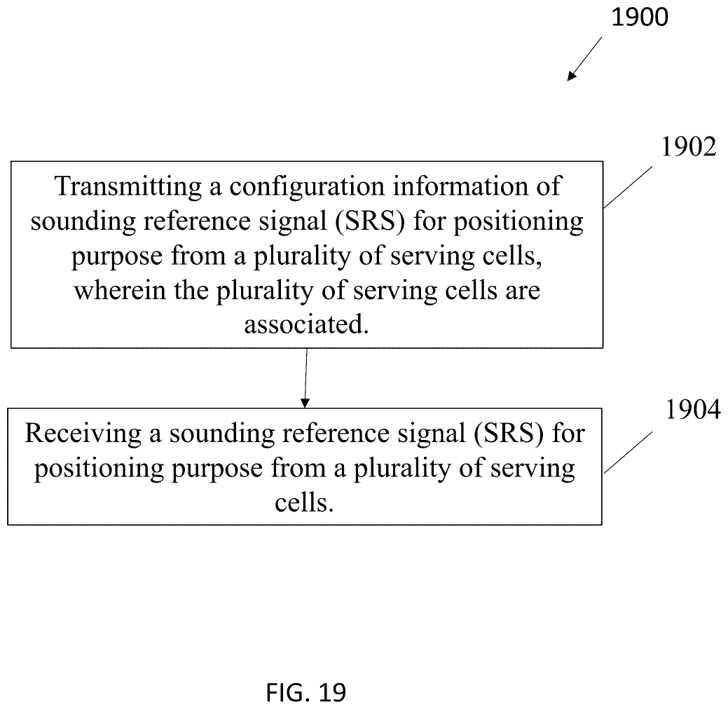

In another example aspect (e.g., as depicted in FIG. 19), another wireless communication method is disclosed. The method includes transmitting (1902), by a network device to a wireless device, a configuration information of sounding reference signal (SRS) for positioning purpose in a plurality of serving cells, wherein the plurality of serving cells are associated, and receiving (1904), by a network device from a wireless device, a sounding reference signal (SRS) for positioning purpose in a plurality of serving cells.

In some embodiments, wherein the SRS comprises a common parameter shared by the plurality of serving cells.

In some embodiments, wherein the common parameter comprises at least one of source reference signal (SRS) source ID, SRS resource set ID, SRS resource ID list, resource type (aperiodic, semi-persistent, periodic), alpha value for SRS power control, p0 value for SRS power control, pathloss reference RS, number of SRS port, transmission comb size, comb offset, cyclic shift, resource mapping, frequency domain shift, frequency hopping, group or sequence hopping, sequence ID, spatial relation information.

In some embodiments, the SRS in a plurality of serving cells is scheduled by a single scheduling grant, the scheduling grant can be either Downlink control information (DCI), Radio Resource Control (RRC) or MAC CE

In some embodiments, the above methods further comprising transmitting a time offset information among serving cells to the wireless device.

It will be appreciated that the present document discloses methods and apparatus related to positioning enhancement. In Carrier Aggregation (CA), two or more Component Carriers (CCs) are aggregated. A UE may simultaneously receive or transmit on one or multiple CCs depending on its capabilities. It is possible to achieve higher positioning accuracy by enlarging the positioning RS (e.g., PRS, SRS for positioning purpose) bandwidth through carrier aggregation technology. However, there is no method to solve the positioning configuration in CA scenario. In this patent application, methods, and procedures of signaling transfer are provided to specify positioning in CA scenarios. The proposed methods are beneficial at least for increasing the accuracy and efficiency of positioning procedure in wireless communication networks.

Various preferred embodiments and additional features of the above-described method of FIGS. 16-19. Further examples are described with reference to embodiments 1 to 7.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communication, comprising:
receiving, by a wireless device from a network device, a configuration information of positioning reference signal (PRS) related to a plurality of positioning frequency layers, wherein the plurality of positioning frequency layers are associated with each other;
measuring, by the wireless device, a positioning reference signal related to positioning frequency layers of the plurality of positioning frequency layers based on the configuration information; and
reporting, by the wireless device to the network device, the positioning measurements related to the positioning frequency layers based on the configuration information.

2. The method of claim 1, wherein the configuration information is received, by the wireless device from the network device, in response to a request for the configuration information transmitted from the wireless device to the network device.

3. The method of claim 2, wherein the request comprises a request for an association between positioning frequency layers.

4. The method of claim 3, wherein each positioning frequency layer group comprises at least two positioning frequency layers, and wherein the at least two positioning frequency layers within the each positioning frequency layer group share one or more common features comprising at least one of:
a Subcarrier Spacing (SCS); a PRS periodicity; a PRS resource set slot offset; a PRS resource repetition factor; a time gap; a muting pattern; a PRS symbol number; a PRS resource symbol offset; a PRS comb size; a PRS Quasi Co Location (QCL) info; or a PRS transmission power.

5. A method for wireless communication, comprising:
receiving, by a wireless device from a network device, a configuration information of sounding reference signal (SRS) for positioning in a plurality of serving cells, wherein the plurality of serving cells are associated with each other; and
transmitting, by the wireless device to the network device, a sounding reference signal (SRS) for positioning in the plurality of serving cells.

6. The method of claim 5, wherein the SRS comprises a common parameter shared by the plurality of serving cells.

7. The method of claim 6, wherein the common parameter comprises at least one of:
a resource type, an alpha value for SRS power control, a p0 value for SRS power control, a transmission comb size, a resource mapping, or a spatial relation information.

8. The method of claim 5, wherein the SRS in the plurality of serving cells is scheduled by a single scheduling grant, the scheduling grant comprises a Downlink Control Information (DCI) or a Medium Access Control Control Element (MAC CE).

9. A method for wireless communication, comprising:
transmitting, by a network device to a wireless device, a configuration information of sounding reference signal (SRS) for positioning in a plurality of serving cells, wherein the plurality of serving cells are associated with each other; and
receiving, by the network device from the wireless device, a sounding reference signal (SRS) for positioning in the plurality of serving cells.

10. The method of claim 9, wherein the SRS comprises a common parameter shared by the plurality of serving cells.

11. The method of claim 10, wherein the common parameter comprises at least one of:
a resource type, an alpha value for SRS power control, a p0 value for SRS power control, a transmission comb size, a resource mapping, or a spatial relation information.

12. The method of claim 9, wherein the SRS in the plurality of serving cells is scheduled by a single scheduling grant, the scheduling grant comprises a Downlink Control Information (DCI) or a Medium Access Control Control Element (MAC CE).

13. A device for wireless communication, comprising at least one processor configured to cause the device to:
receive, from a network device, a configuration information of positioning reference signal (PRS) related to a plurality of positioning frequency layers, wherein the plurality of positioning frequency layers are associated with each other;
measure a positioning reference signal related to positioning frequency layers of the plurality of positioning frequency layers based on the configuration information; and
report, to the network device, the positioning measurements related to the positioning frequency layers based on the configuration information.

14. The device of claim 13, wherein the at least one processor is further configured to cause the device to transmit a request for the configuration information to the network device.

15. The device of claim 14, wherein the request comprises a request for an association between positioning frequency layers.

16. The device of claim 15, wherein each positioning frequency layer group comprises at least two positioning frequency layers, and wherein the at least two positioning frequency layers within the each positioning frequency layer group share one or more common features comprising at least one of:
a Subcarrier Spacing (SCS); a PRS periodicity; a PRS resource set slot offset; a PRS resource repetition factor; a time gap; a muting pattern; a PRS symbol number; a PRS resource symbol offset; a PRS comb size; a PRS Quasi Co Location (QCL) info; or a PRS transmission power.

17. The device of claim 13, wherein the configuration information comprises a bandwidth information that is associated with a value representing a maximum bandwidth configured for one positioning frequency layer and a number representing a maximum number of bandwidths to be aggregated.
